(19) United States
(12) Patent Application Publication
(10) Pub. No.: US 2026/0357135 A1
(43) Pub. Date: Nov. 12, 2026

(54) Methods for Providing Pyrolysis Oil from Holocellulose and Lignin Comprising Biomass

(71) Applicant: BTG BioLiquids B.V., Enschede (NL)

(72) Inventors: Tijs Merijn Lammens, Enschede (NL); Adrianus Aegidius Johannes Toussaint, Enschede (NL); Robertus Hendrikus Venderbosch, Enschede (NL)

(21) Appl. No.: 19/125,808

(22) PCT Filed: Oct. 31, 2022
(86) PCT No.: PCT/EP2022/080384

§ 371 Date: Apr. 30, 2025

(51) Int. Cl. C10B 49/20; C10B 53/02; C10G 1/02

(52) U.S. Cl. CPC C10B 49/20; C10B 53/02; C10G 1/02; C10G 2300/1003; C10G 2300/1014

(57) ABSTRACT

The present invention relates to methods for providing pyrolysis oil from holocellulose and lignin including biomass. The present methods provide, amongst others, an improved pyrolysis oil/char ratio or higher yield. The present methods additionally provide, amongst others, pyrolysis oils with improved carbon (C)/oxygen (O) ratios or energy content.

### CROSS-REFERENCE TO RELATED APPLICATION

This application is the United States national phase of International Patent Application No. PCT/EP2022/080384 filed Oct. 31, 2022, the disclosure of which is hereby incorporated by reference in its entirety.

### BACKGROUND OF THE INVENTION

### Field of the Invention

The present invention relates to methods for providing pyrolysis oil from holocellulose and lignin comprising biomass. The present methods provide, amongst others, an improved pyrolysis oil/char ratio or higher yield. The present methods additionally provide, amongst others, pyrolysis oils with improved carbon (C)/oxygen (O) ratios or energy content.

Fast pyrolysis, like slow pyrolysis, is the heating of biomass in the absence of oxygen. Unlike slow pyrolysis, fast pyrolysis generally uses high heating rates, short residence times, and rapid quenching of vapours to maximize production of an organic liquid oily product, also designated as bio-oil or pyrolysis oil.

### Description of Related Art

Fast pyrolysis of biomass, with high heating rates and fast vapor cooling allows for minimizing secondary cracking reactions and repolymerization. By operating at elevated temperatures, relatively high yields of pyrolysis oil can be obtained. Fast pyrolysis of biomass is usually combined with pre-treatments of biomass including drying the biomass to less than 10 wt. % water and milling the biomass to particles sizes of 2 to 3 mm. Several technologies for fast pyrolysis are, or heave been, commercially exploited:
fast Pyrolysis processes developed by, amongst others, Dynamotive Energy Systems Corporation using a fluidized bed reactor;
A RTP (Rapid Thermal Processing) processes developed by Ensyn Technologies with a transport diluted fluidized bed; and
A fast pyrolysis process developed by Savon Voima using a fluidized bed reactor; and
fast pyrolysis processes developed by Biomass Technology Group using a modified rotating cone reactor.

In the first three technologies, a recirculation of non-condensable products induces the fluidization of the bed, wherein the rate thereof determines the vapor residence time in the reactor. In all cases, part of the gases produced are used to provide energy for the pyrolysis. In the RTP process, particularly, a hot transport diluted fluidized bed, usually sand, is circulated between two reactors: the first one is devoted to pyrolysis, while the second one reheats the sand particles by burning off the char formed during the pyrolysis.

On the contrary, the process commercialized by BTG is based on an intensive mixing of the biomass particles with hot sand in a modified rotating cone reactor. As no carrier gas is used, the volume of vapours exiting the reactor is much lower than in fluidized bed reactors and, consequently, the size of the condenser to recover bio-oil is smaller than in other technologies. The stream of solids, containing char and sand particles, is recycled to the combustion section, where char burning off provides the energy needed to reheat the sand particles that are sent back to the pyrolysis reactor.

Even though fast pyrolysis technologies are commercially available, there is a continuous need in the art to improve fast pyrolysis process parameters, for example to optimize yield, to lower water content and/or to increase energy content of the resulting pyrolysis oil.

### SUMMARY OF THE INVENTION

It is an object of the present invention, amongst other objects, to meet the above needs in the art.

The above needs are met by the present invention as outlined in the appended claims.

Specifically, the above needs are met by the present invention by methods for providing pyrolysis oil from holocellulose and lignin comprising biomass, the methods comprise the steps of:
a) separately introducing the biomass and a solid heat carrier with a temperature of 400 °C to 700 °C into a first reactor or first reaction zone;
b) continuous mixing, in the absence of oxygen, of the biomass and solid heat carrier in the first reactor or the first reaction zone for providing a first time period of 0.5 to 5 seconds of pyrolytic processing yielding a mixture comprising partially pyrolyzed biomass and solid heat carrier and primary pyrolysis gas;
b1) optionally, collecting primary pyrolysis gas from the first reactor, or first reaction zone;
c) introducing the mixture from the first reactor, or first reaction zone, into a second reactor, or second reaction zone, the second reactor, or second reaction zone, is configured to provide sedimentation, or separation, of solids at the bottom of the second reactor, or second reaction zone, by gravity thereby forming a layer of solids at the bottom of the second reactor, or second reaction zone;
d) maintaining the mixture in the second reactor, or reaction zone, in the absence of oxygen, for a second time period of 10 to 1200 seconds of pyrolytic processing additionally yielding secondary pyrolysis gas and solid char, while collecting pyrolysis gasses from the second reactor, or reaction zone;
e) condensing, preferably by quenching to temperatures of 60 °C or less, the collected primary and secondary pyrolysis gasses into pyrolysis oil.

The present inventors have surprisingly found that by increasing, as compared to the prior art, the time period for pyrolytic processing in the second reactor, pyrolysis oil yields are increased, the resulting pyrolysis oils have a lower water content and/or the energy content of the resulting pyrolysis oils was increased as indicated by higher carbon (C)/oxygen (O) ratios.

Without wishing to be limited to an underlying mechanism, the present inventors postulate that holocellulose (hemicellulose and cellulose) present in the biomass is mainly pyrolytically processed (cracked) in the first reactor, or reaction zone, while the increased time period in the second reactor, or reaction zone, allows for an additional pyrolytic processing (cracking) of, amongst others, lignin.

In the methods according to the present invention, no further heat is introduced into the method apart of the heat provided by the heat carrier introduced into the first reactor or reaction zone.

According to the present invention, the present method can be carried out in separate reactor vessels or in a single apparatus comprising separated reaction zones allowing the required mixing and separation.

According to the present invention, the layer of solids, generally comprised of sand and char, at the bottom of the second reactor, or reaction zone, is considered essential for preventing oxygen to enter the second reactor or reaction zone.

According to a preferred embodiment of the present invention, the second time period time is determined by the height of the layer, or dipleg, of solids, sedimented, or separated, at the bottom of the second reactor or reaction zone. The solids mainly are a mixture of heat carrier and (partially) pyrolytically processed biomass or char.

According to an especially preferred embodiment of the present invention, the height of the layer of sedimented or separated solids at the bottom of the second reactor, or second reaction zone, controls the second time period, wherein an increased height increases the second time period. In the second reactor, or reaction zone, the height of the layer of solids at the bottom can be readily controlled using a level controller allowing removal of solids from the bottom of the second reactor, or reaction zone.

According to a preferred embodiment of the present invention, the second time period in the present methods is 10 to 900 seconds, preferably 50 to 900 seconds, more preferably 100 to 900 seconds, most preferably 200 to 720 seconds.

According to the present invention, the present solid heat carrier is selected from the group consisting of siliceous minerals, catalytic minerals, metals, zeolites, and sand. Sand is preferred since it is a readily available and inert material.

The present methods provide pyrolysis oils with an increased C content, pyrolysis oils with an increased oil/char ratio or yield and/or pyrolysis oils with an increased C/O ratio or energy content.

Suitable holocellulose and lignin comprising biomasses used in the present methods can be selected from the group consisting of wood, wood derived products, agricultural products, agricultural waste products, horticultural products, horticultural waste products, forestry products, forestry waste products, waste products of the human or animal food processing industry, wood chips, saw dust, wood pellets, bark, seeds, kernels, husks, and combinations thereof.

According to the present invention, the first time period is determined by the volume of the first reactor, or reaction zone, and the feed rate of biomass and solid heat carrier, i.e., the first reactor, or reaction zone, is configured and operated to provide a residence time of 0.5 to 5 seconds.

The present methods are preferably continuous processes, i.e., biomass and solid heat carrier are continuously supplied to the first reactor, or reaction zone, pyrolysis gasses are continuously collected from the reactor(s), or reaction zone(s), and solid heat carrier and char are continuously removed from the second reactor, or reaction zone.

Preferably, the moisture content of the biomass is less than 10 wt. %, preferably less than 5 wt. %, more preferably less than 3 wt. % or less than 4 wt. %.

According to the present invention, the temperature of the heat carrier in step (a) is preferably 450 °C to 650 °C, more preferably 450 °C to 600 °C.

According to a preferred embodiment of the present invention, the first reactor, or first reaction zone, comprises mixing means and inlets for the biomass and the heat carrier and an outlet for the mixture comprising partially pyrolyzed biomass and solid heat carrier and, optionally, an outlet for primary pyrolysis gas.

According to also a preferred embodiment of the present invention, the second reactor, or second reaction zone, comprises means for separating solid particles and gasses by gravity, the second reactor further comprises an inlet for the mixture comprising partially pyrolyzed biomass and solid heat carrier, an outlet for solids sedimented, or separated, at the bottom of the second reactor, and an outlet for pyrolysis gas.

### BRIEF DESCRIPTION OF THE DRAWINGS

The present invention will be further detailed in the following example. In the example, reference is made to figures wherein:

FIG. 1: shows a schematic representation of the present methods; Top of FIG. 1 shows an embodiment wherein pyrolysis gasses are collected from the first and second reactors. Bottom of FIG. 1 shows an embodiment wherein gasses are collected from the second reactor.

FIG. 2: shows a schematic representation of the second reactor with different heights of the layer (grey area), or dipleg, of solids, sedimented, or separated, at the bottom of the second reactor;

FIG. 3: graphically shows the relation between yield, carbon content and energy content of pyrolysis oil and residence time in the second reactor or reaction zone;

FIG. 4: graphically shows the relation between char production and residence time in the second reactor or reaction zone.

### EXAMPLE

### Description of the Invention

### Introduction

According to the present invention, pyrolysis of biomass can be distinguished into two stages: 1) cracking of the holocellulose (hemicellulose and cellulose) and 2) cracking of the lignin. Both stages yield different products and optimally require two cracking strategies. The first cracking strategy generally comprises a fast temperature increase to crack holocellulose and a subsequent fast cooling of the resulting pyrolysis gases (primary gases) to prevent a subsequent conversion into permanent gases and water. The second cracking strategy generally comprising subjecting lignin to high temperatures but, in contrast with cracking holocellulose, maintain the lignin at high temperatures to obtain sufficient conversion thereof. The gasses produced are guided through the hot bed of sand to crack further, in order to get short chain carbon products (secondary pyrolysis gases).

The present invention is directed to methods wherein both pyrolysis stages are optimally combined in a single pyrolysis process. The present methods provide the advantages of:
1) a higher quality oil (less water, more organic, more acids-emulsifier, smaller phenolic chains—less polar and less prone to phase separation);
2) less cracked “non-condensable gases” from the primary gases gives higher oil yields.
3) increased cracking of lignin provides less “char” and therefore a higher oil yield.

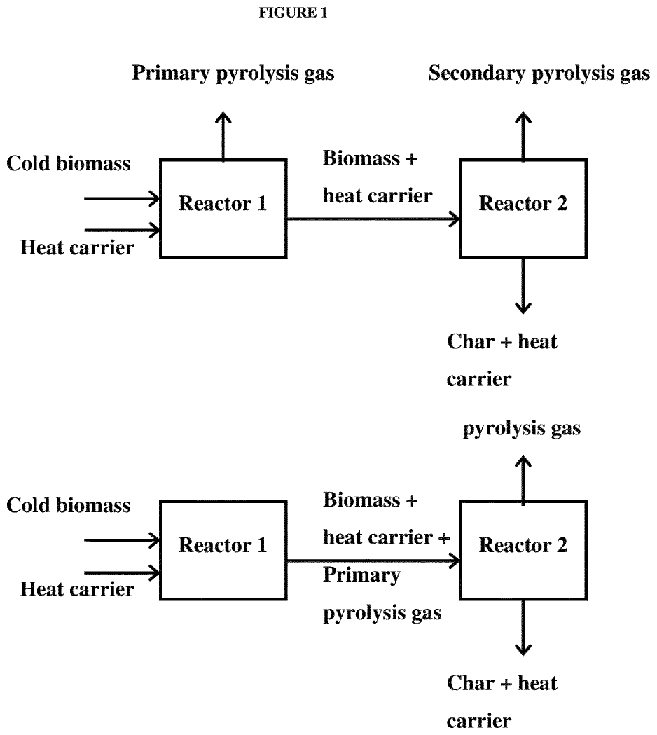

An example of the present method is schematically represented in FIG. 1. The present method uses two reactors, wherein biomass and a heat carrier are supplied to a first reactor configured to provide a residence time of 0.5 to 5 seconds. Subsequently, the partly pyrolyzed biomass is fed into a second reactor configured to allow a residence time of 10 to 1200 seconds.

Specifically, biomass and heat carrier (sand) is fed into reactor 1, where they are immediately physically mixed. In reactor 1, “rapid pyrolysis” takes place, characterized by rapid warming of biomass and short residence time of the primary gases. Residence time of the primary gases is as small as possible (order of magnitude 0.5-5 sec).

A mix of biomass, heat carrier (sand) and cracking gases from rapid pyrolysis leave reactor 1 towards the reactor 2 (separator). The primary pyrolysis gases of rapid pyrolysis go directly up in the separator and heat carrier (sand) and solid biomass (incompletely cracked due to the short residence time in the first reactor) goes down in separator (gravity).

The solids form a layer (dipleg) that slowly sinks down in the separator (residence time approximately between 10 and 900 sec). Because of the high temperature in the dipleg (generally >350 °C), the lignin “cracks through”, and the remaining materials create gases that move upwards through the hot sand bed and eventually forming secondary pyrolysis gas.

The combination of primary gases and secondary gases are condensed into a liquid (pyrolysis oil), for example via cyclones while the heat carrier (sand) and fully converted biomass (char) leave the separator via the bottom.

### Experimental Setup

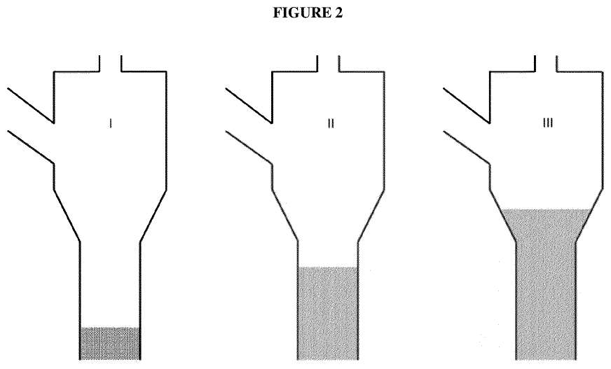

Pyrolysis was performed using a mini pilot plant with a dipleg sand height at 3 different levels (as schematically shown in FIG. 2) to demonstrate effects of the residence time of lignin in the dipleg on the quality and yield of the resulting pyrolysis oil.

Specifically, three experiments were performed using woody biomass, clean sand and a start-up liquid, wherein the output of the screw for removing sand and char under the separator (reactor 2) was varied between the experiments in such a way that different height levels (I, II, and III) of the dipleg were provided for each run while keeping other operational parameters constant. The different height levels used were: I=very low, on the edge of oxygen transfer; II=low level; III=high level. In the experimental setup used, the resulting residence times in the second reactor were: III: 11 minutes (run 1); II: 4.5 minutes (run 2); I: 3.6 minutes (run 3).

### Results

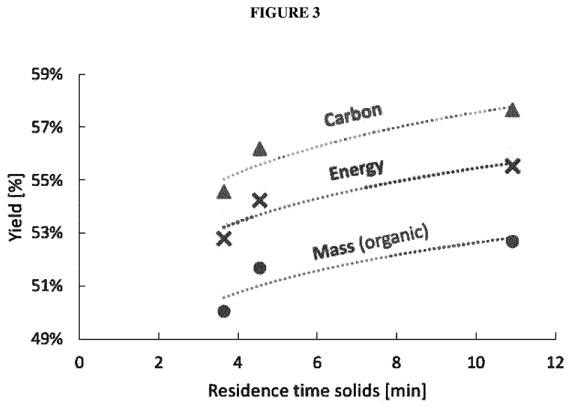

As shown in FIG. 3 and the tables below, a higher quality pyrolysis oil was obtained at a higher separator level because of:
1) More organic components indicated by an increased C/O ratio;
2) Lower water content in pyrolysis oil;

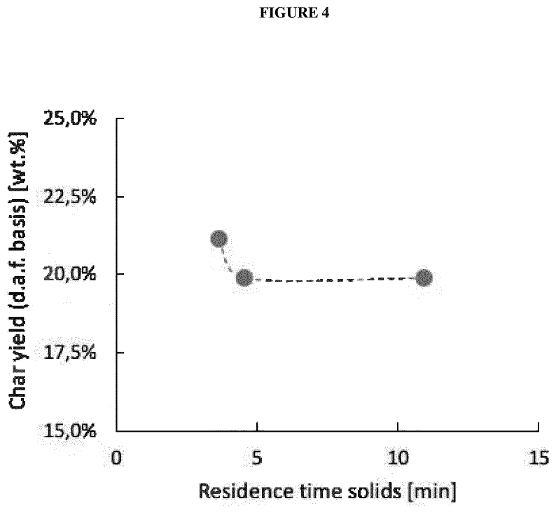

As shown in FIG. 4 and the tables below, a higher oil/char yield ratio (mass balance) was obtained.

TABLE 1
Mass Balance [as received]

| | Run 1 | Run 2 | Run 3 |
|---|---|---|---|
| Overall | 103.2% | 103.9% | 102.7% |
| Oil yield | 64.7% | 63.7% | 62.4% |
| Gas yield | 18.9% | 20.7% | 19.5% |
| Char yield | 19.4% | 19.4% | 20.6% |
| Ash yield | 0.2% | 0.2% | 0.2% |

TABLE 2
Mass Balance [dry ash free]

| | Run 1 | Run 2 | Run 3 |
|---|---|---|---|
| Overall | 103.3% | 104.1% | 102.8% |
| Organic liquid | 52.7% | 51.7% | 50.0% |
| Water | 11.3% | 11.2% | 11.6% |
| Gas | 19.4% | 21.3% | 20.0% |
| Char | 19.9% | 19.9% | 21.1% |

TABLE 3
FPBO composition [as received]

| | | Run 1 | Run 2 | Run 3 |
|---|---|---|---|---|
| C | [wt. %] | 42.5 | 42.1 | 41.7 |
| H | [wt. %] | 6.8 | 6.9 | 7.0 |
| N | [wt. %] | 0.13 | 0.10 | 0.10 |
| O | [wt. %] | 50.5 | 50.9 | 51.2 |
| Water | [wt. %] | 20.76 | 20.98 | 21.94 |
| HHV | [MJ/kg] | 16.62 | 16.52 | 16.44 |
| LHV | [MJ/kg] | 15.12 | 15.01 | 14.90 |

TABLE 4
Gas composition [N₂ free]

| | | Run 1 | Run 2 | Run 3 |
|---|---|---|---|---|
| H₂ | [vol. %] | 0 | 0 | 0 |
| CO | [vol. %] | 48 | 49 | 50 |
| CO₂ | [vol. %] | 39 | 36 | 36 |
| CH₄ | [vol. %] | 10 | 10 | 10 |
| C₂+ | [vol. %] | 4 | 5 | 5 |

TABLE 5
Char composition [dry]

| | | Run 1 | Run 2 | Run 3 |
|---|---|---|---|---|
| C | [wt. %] | 77 | 77 | 73 |
| H | [wt. %] | 2 | 3 | 3 |
| N | [wt. %] | 1 | 1 | 1 |
| O | [wt. %] | 19 | 19 | 23 |
| (by difference) | | | | |

1. A method for providing pyrolysis oil from holocellulose and lignin comprising biomass, the method comprising the steps:
a) separately introducing the biomass and a solid heat carrier with a temperature of 400 °C to 700 °C into a first reactor or first reaction zone;
b) continuously mixing, in the absence of oxygen, of the biomass and solid heat carrier in the first reactor or the first reaction zone for a first time period of 0.5 to 5 seconds of pyrolytic processing yielding a mixture comprising partially pyrolyzed biomass and solid heat carrier and primary pyrolysis gas;
b1) optionally, collecting primary pyrolysis gas from the first reactor, or first reaction zone;
c) introducing the mixture from the first reactor, or first reaction zone, into a second reactor or second reaction zone, the second reactor; or second reaction zone is configured to provide sedimentation, or separation, of solids at the bottom of the second reactor; or second reaction zone; by gravity, thereby forming a layer of solids at the bottom of the second reactor; or second reaction zone;
d) maintaining the mixture in the second reactor or second reaction zone in the absence of oxygen for a second time period of 10 to 1200 seconds of pyrolytic processing additionally yielding secondary pyrolysis gas and solid char, while collecting pyrolysis gasses from the second reactor or se d reaction zone;
e) condensing the collected primary and secondary pyrolysis gasses into pyrolysis oil.

2. The method according to claim 1, wherein the second time period for pyrolytic processing is determined by the height of the layer of solids sedimented, or separated, at the bottom of the second reactor; or second reaction zone.

3. The method according to claim 2, wherein the height of the layer of sedimented or separated solids at the bottom of the second reactor or second reaction zone controls the second time period, wherein an increased height increases the second time period.

4. The method according to claim 1, wherein the second time period for pyrolytic processing is 10 to 900 seconds.

5. The method according to claim 1, wherein the solid heat carrier is selected from the group consisting of siliceous minerals, catalytic minerals, metals, zeolites, and sand.

6. The method according to claim 1, wherein the method provides pyrolysis oil with an increased C content.

7. The method according to claim 1, wherein the method provides pyrolysis oil with an increased oil/char ratio or yield.

8. The method according to claim 1, wherein the method provides pyrolysis oil with an increased C/O ratio or energy content.

9. The method according to claim 1, wherein holocellulose and lignin comprising biomass is selected from the group consisting of wood, wood derived products, agricultural products, agricultural waste products, horticultural products, horticultural waste products, forestry products, forestry waste products, waste products of the human or animal; food processing industry, wood chips, saw dust, wood pellets, bark, seeds, kernels, husks, and combinations thereof.

10. The method according to claim 1, wherein the first time period is determined by the volume of the first reactor and the feed rate of biomass and solid heat carrier.

11. The method according to claim 1, wherein the method is a continuous process.

12. The method according to claim 1, wherein the moisture content of the biomass is less than 10 wt. %.

13. The method according to claim 1, wherein the temperature of the heat carrier in step (a) is 450 °C to 650 °C.

14. The method according to claim 1, wherein the first reactor or first reaction zone comprises mixing means and inlets for the biomass and the heat carrier and an outlet for the mixture comprising partially pyrolyzed biomass and solid heat carrier and, optionally, an outlet for primary pyrolysis gas.

15. The method according to claim 1, wherein the second reactor or second reaction zone comprises means for separating solid particles and gasses by gravity, and wherein the second reactor or second reaction zone further comprises an inlet for the mixture comprising partially pyrolyzed biomass and solid heat carrier, an outlet for solids sedimented, or separated, at the bottom of the second reactor, and an outlet for pyrolysis gas.
